(19) United States
(12) Patent Application Publication
(10) Pub. No.: US 2008/0066748 A1
(43) Pub. Date: Mar. 20, 2008

(54) Breathing Gas Supply Visual Broadcast Apparatus and Method

(75) Inventors: Gary Felske, Newbern, NC (US); Chris Berg, Mead, WA (US)

Correspondence Address: SCHWEGMAN, LUNDBERG & WOESSNER, P.A., P.O. BOX 2938, MINNEAPOLIS, MN, 55402, US

(73) Assignee: AVAIR, LLC, Charlotte, NC (US)

(21) Appl. No.: 11/849,993

(22) Filed: Sep. 4, 2007

Related U.S. Application Data
(60) Provisional application No. 60/824,303, filed on Sep. 1, 2006.

(51) Int. Cl. A62B 27/00; G08B 5/00

(52) U.S. Cl. 128/202.22; 128/201.27; 128/205.23

(57) ABSTRACT

Methods and apparatus for monitoring a condition of a breathing gas supply by illuminating optically distinct regions that are visible to a user, and by others in a common group, are provided. The breathing gas supply apparatus includes a sensor, processing circuitry, memory, a power supply, and a flexible light transmissive tube having a distributed light source. The sensor detects a condition of a breathing gas supply and generates an output signal correlated with the detected condition. The memory communicates with the processing circuitry and stores the output signal in memory. The flexible light transmissive tube communicates at a proximal end with the pressure sensor and at a distal end with the power supply. The distributed light source illuminates a plurality of optically distinct regions within the tube, where each illuminated region indicates the detected condition of the breathing gas supply within a predetermined value.

### RELATED PATENT DATA

This application claims priority from U.S. Provisional Patent Application Ser. No. 60/824,303, filed on Sep. 1, 2006, the complete subject matter of which is expressly incorporated herein by reference in its entirety.

### TECHNICAL FIELD

Embodiments of the present invention pertain generally to breathing gas supply status indicators, and more particularly pertain to breathing gas supply systems, air supply planning systems, and visual broadcast systems that provide condition/status information for a breathing gas supply.

### BACKGROUND OF THE INVENTION

Breathing gas is stored and delivered to individuals in a number of hostile environments. For example, scuba divers, firefighters, high-altitude explorers, airplane pilots, emergency workers and the like oftentimes carry compressed air supplies in tanks. The air supply is metered to the wearer via a regulator. Additionally, in the case of scuba divers, other mixed gases are stored and the gas supply is similarly metered, particularly for deep diving applications, to the wearer. As the user goes about his/her activities, it is desirable to manage the user's activities based on a condition of the air or gas supply (e.g., gas pressure). Typically, the pressure of the air or gas is monitored by the user in order to estimate the remaining amount of gas in the tank. In this way, for example, a diver or a firefighter may estimate the time for which they may remain in the environment.

For the case of scuba diving, one of the principal requirements as dictated by certification organizations is proper attention to the amount of air remaining in the diver's air supply tank. The amount of remaining air in a diver's tank becomes critically important in the cases of cave diving, wreck diving, and ice diving. Typically, this is accomplished by a user frequently referring to an air supply gauge that mounts on the end of a pressure hose extending from a scuba tank regulator which forms part of the diver's safety gear. In order to do this, the diver is required to locate, retrieve and manipulate the gas into view in close proximity of the diver's mask, enabling the diver to view and read the gauge. Inattention to the quantity of air remaining in the tank may result in a diver ascending too quickly to the surface, once the diver recognizes that the air supply is critically low. A too-rapid ascent may result in serious injury or death from decompression-related injury.

The problem of monitoring gas and air condition is further exacerbated where a scuba diving guide, or instructor, is leading a group of student/novice scuba divers on an underwater excursion or is providing open water instruction on dive techniques to a group of students. The guide needs to be conscious of the fact that each student diver consumes air at a different rate. For example, an expert scuba diver may use one-third the amount of air that a novice diver may uses. Accordingly, the guide or instructor has to keep reminding the group of students to check their individual air pressure gauges. Typically, the instructor uses hand signals underwater to remind the students to check the pressure gauge, which is not necessarily accurate because a student may not notice the instructor's hand signal and, therefore, may not check the air pressure gauge. However, if the instructor is concerned about the state of a particular student's air supply, the instructor typically swims over to the particular student diver and manually checks the student diver's pressure gauge in order to verify the air supply is adequate for the period of time the group has been diving. Even when a student diver understands and accurately observes the specific hand signals, he or she may give the guide an “OK-sign” to indicate that their air supply is sufficient, when in actuality the air pressure is insufficient. For instance, the student diver may incorrectly believe his/her air supply is at an adequate level or sufficient, or the student diver may misread the pressure gauge before giving the “OK-sign.” However, sometimes the student diver will incorrectly give the “OK-sign” to indicate that they have enough air pressure to remain submerged for a longer duration of time when instead they should immediately commence returning to the surface because they do not have enough air pressure in the tank. For instance, an adequate pressure of 1000 psi may be required for the student to return to the surface at a sufficiently slow rate to avoid injury from expanding blood and lung gases (e.g., the bends). As a result of incorrectly reading the air pressure gauge or not frequently checking the air pressure gauge, some divers may allow the air pressure in the tank to drop to less than the required air pressure needed (e.g., a few hundred psi) before beginning a safe ascent.

Thus, it is desirable to manage the user's activities based on a condition of the air or gas supply (e.g., gas pressure). Accordingly, improvements are needed for increasing the ability to discern a condition of one or more gas supplies by one or more individuals, such as by guides and instructors. This need is particularly relevant for individuals using pressurized air supplies so the individual and members of a group may identify when the air supply is running low without having to look at a pressure gauge.

Also accordingly, there is a need for a breathing gas supply that allows a user of a pressurized air supply to know when their gas supply is running low without having to manipulate a pressure gauge by broadcasting visually a status of the gas supply. There is also a need for a breathing gas supply status indicator that allows others in the vicinity of the user of a pressurized gas supply to observe the status of the gas supply for the user. Further, there is also a need to concurrently provide a user with a corresponding audible status alert when the gas supply is below a predetermined level.

### SUMMARY OF THE INVENTION

In one embodiment of the invention, a user interface for a breathing gas supply system is provided. The user interface includes a distributed light source having a plurality of illumination zones, each illumination zone correlated with a condition of the gas in a breathing gas supply system.

In another embodiment of the invention, an air supply status indicator is provided. The status indictors include an elongate light tube having a plurality of unique, optically discernible illumination regions each viewable about an entire cross-sectional periphery of the tube.

In an alternative embodiment of the invention, an apparatus for monitoring a condition of a breathing gas supply by illuminating optically distinct regions that are visible to a user, and by others in a common group, are provided. The breathing gas supply apparatus includes a sensor, processing circuitry, memory, a power supply, and a flexible light transmissive tube having a distributed light source. The sensor detects a condition of a breathing gas supply and generates an output signal correlated with the detected condition. The memory communicates with the processing circuitry and stores the output signal in memory. The flexible light transmissive tube communicates at a proximal end with the pressure sensor and at a distal end with the power supply. The distributed light source illuminates a plurality of optically distinct regions within the tube, where each illuminated region indicates the detected condition of the breathing gas supply within a predetermined value.

Optionally, in another embodiment of the invention, a method for planning a scuba diving event is provided where a scuba diver utilizes the breathing gas supply apparatus having a tank with a pressure gauge connected to a sensor that detects a pressure of the gas supply and communicatively coupled to the plurality of lights. The method includes checking that at least one set of lights are illuminated to indicate the gas supply is full and at a predetermined level, diving under a body of water, verifying a first plurality of lights remain illuminated in the water and visible as the diver descends deeper in the body of water, and monitoring for a change in the lights as the sensor determines changes in the gas pressure.

### BRIEF DESCRIPTION OF THE DRAWINGS

In the drawings, which are not necessarily drawn to scale, like numerals describe substantially similar components throughout the several views. Like numerals having different letter suffixes represent different instance of substantially similar components. The drawings illustrate generally, by way of example, but not by way of limitation, various embodiments discussed in the present document.

FIG. 1 is a perspective view of a scuba diver with a scuba tank and regulator using a breathing gas supply visual broadcast apparatus according to one aspect of the present invention.

FIG. 2 is a perspective view of scuba diving instructor and a group of scuba diving students each using the breathing gas supply visual broadcast apparatus of FIG. 1 during an open water instruction dive.

FIG. 3 is an enlarged partial perspective view of the scuba diver of FIG. 1 further illustrating placement of the breathing gas supply visual broadcast apparatus of FIGS. 1-2 affixed between a first stage scuba regulator and an inflation tube for a buoyancy compensator.

FIG. 4 is a perspective view of the breathing gas supply visual broadcast apparatus of FIGS. 1-3 prior to being mounted onto a scuba regulator and buoyancy compensator.

FIG. 5 is a block diagram illustrating operating components for the breathing gas supply visual broadcast apparatus of FIGS. 1-4.

FIG. 6 is an enlarged perspective view of a component of the flexible tube for the breathing gas supply visual broadcast apparatus of FIGS. 1-5.

FIG. 7 is an enlarged component perspective view of a select LED assembly from within the tube of FIG. 6.

FIG. 8 is a plan view from above of the LED assembly of FIG. 7.

FIG. 9 is a partial perspective view depicting an alternative construction for a visual broadcast device that uses a flexible printed circuit board layout with on-board LEDs provided within a flexible light transmissive tube.

FIG. 10 is a partial perspective view for the printed circuit board of FIG. 9.

FIG. 11 is a process flow diagram showing part of the logic processing for initializing, detecting and broadcasting a detected pressure condition with the visual broadcast device of FIGS. 1-8.

FIG. 12 is another alternative construction visual broadcast device depicting a lighted pressure gauge hose of a scuba regulator.

FIG. 13 is an enlarged perspective view of a distal end of the hose and gauge of FIG. 12.

FIG. 14 is a further alternative construction for a gauge over that depicted in the construction of FIG. 13.

FIG. 15 is yet another construction visual broadcast device depicting a lighted tubular cover that assembles over a pressure gauge hose of a scuba regulator.

FIG. 16 is a cross-sectional view of the visual broadcast device of FIG. 15 taken along line 16-16 of FIG. 15.

FIG. 17 is a first alternative construction light transmissive tube for use with the visual broadcast devices of FIGS. 1-10 using a snorkel that includes a light transmissive outer covering having LEDs.

FIG. 18 is a second alternative construction light transmissive tube for use with the visual broadcast devices of FIGS. 1-10 using a rigid vertical light transmissive tube that attached to a first stage on a scuba regulator.

FIG. 19 is a third alternative construction light transmissive tube for use with the visual broadcast devices of FIGS. 1-10 using a flexible light transmissive tube similar to that depicted in the construction of FIGS. 1-10, but including a wireless, sonic communication link with a master controller that is provided on a guide or instructor visual broadcast device.

FIG. 20 is a fourth alternative construction light transmissive tube for use with the visual broadcast devices of FIGS. 1-10 using a flexible light transmissive tube similar to that depicted in the construction of FIGS. 1-10, but including a positively buoyant float provided by the battery housing so the tube takes on a vertical orientation when diving.

FIG. 21 is a fifth alternative construction light transmissive tube for use with the visual broadcast devices of FIGS. 1-10 using a flexible light transmissive tube similar to that depicted in the construction of FIGS. 1-10, but including a switch provided by the sensor housing for activating an emergency light beacon with one or more of the LEDs.

FIG. 22 is a sixth alternative construction light transmissive tube for use with the visual broadcast devices of FIGS. 1-10 using a flexible light transmissive tube similar to that depicted in the construction of FIGS. 1-10, but including a laser light on a terminal end of the battery housing that can also be triggered by the controller of the visual broadcast device at a threshold condition.

### DETAILED DESCRIPTION OF THE PREFERRED EMBODIMENTS

In the following detailed description, reference is made to the accompanying drawings which form a part hereof, and which is shown by way of illustration specific embodiments in which the present invention may be practiced. These embodiments, which are also referred to herein as “examples,” are described in sufficient detail to enable those skilled in the art to practice the invention, and it is to be understood that the embodiments may be combined, or that other embodiments may be utilized and that structural, logical and electrical changes may be made without departing form the scope of the present invention. For example, embodiments may be used by scuba divers, firefighters, high-altitude explorers, airplane pilots, emergency workers, and the like. The following detailed description is, therefore, not be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated.

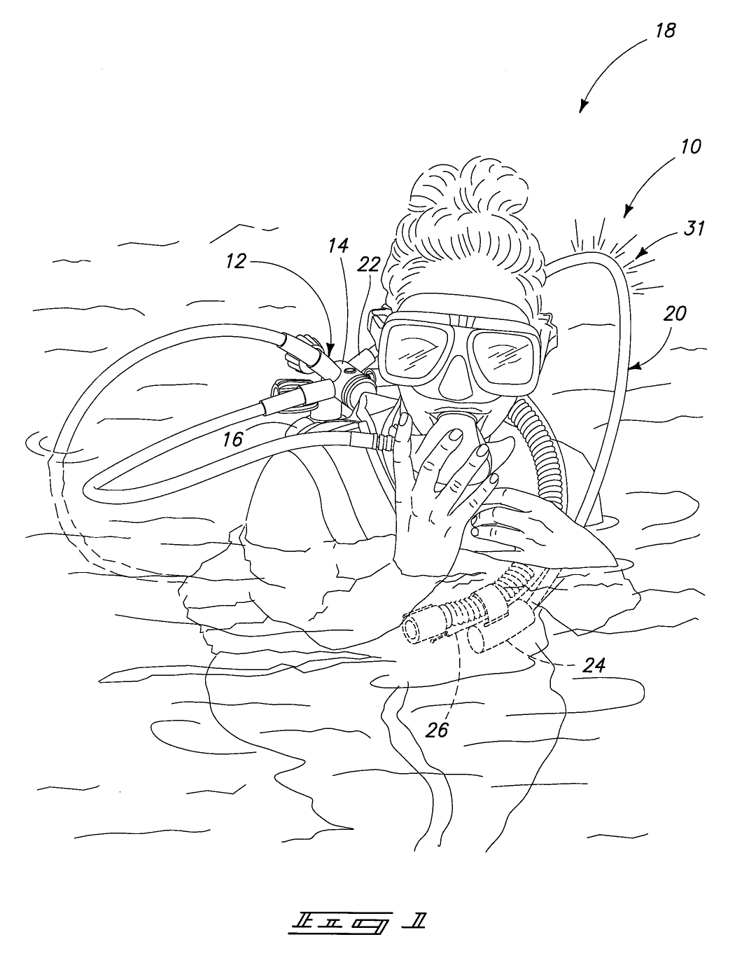

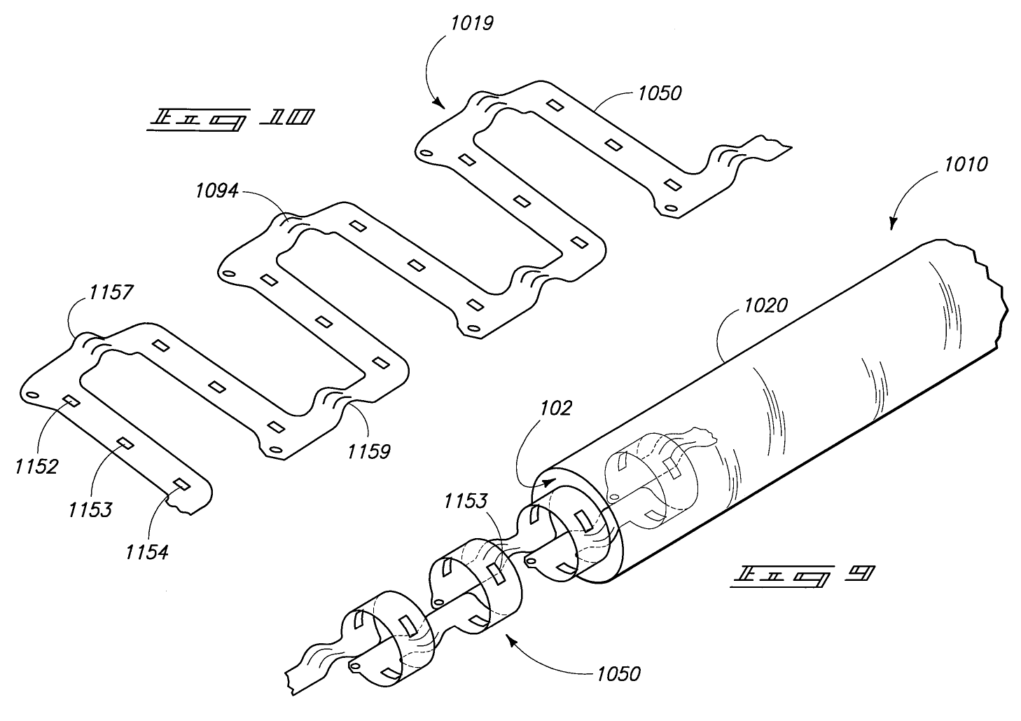

Reference will now be made to embodiments of Applicant's invention for a breathing gas supply visual broadcast apparatus identified by reference numeral 10 in the construction depicted in FIGS. 1-18.

In an effort to prevent obscuring the invention at hand, only details germane to implementing the invention will be described in great detail, with presently understood peripheral details being incorporated by reference, as needed, as being presently understood in the art.

FIG. 1 depicts a scuba diver 18 preparing to re-submerge and having a breathing gas supply in the form of a scuba tank 16 and regulator 12 having a visual gas supply broadcast device 10, according to one aspect of the present invention. Visual broadcast device 10 generates visual and acoustic signals that are discernible by a scuba diver, as well as by companions in a dive group, to alert the divers to a condition of the gas supply in the tank 16. Typically, the condition will be based on a detected air pressure in tank 16, but other forms of detection could be used in order to direct a dive schedule suitable to the detected condition of the gas. For example, illumination zone 31 is lit with yellow light along a central region of tube 20 to indicate that air pressure in tank 16 is at a caution level. Additionally or optionally, an acoustic emitter and detector could also be used to generate a signal that correlates with an amount of gas remaining in tank 16. In most cases, tank 16 will contain compressed air, but it could also contain other breathable mixed gases, such as a nitrous oxide mixed gas.

Visual broadcast device 10 includes a distributed light source in the form of an elongate light pipe, or light tube comprising a flexible light transmissive tube 20 that emits light selectively within each of a plurality of optically distinct illumination regions, or zones within tube 20. Tube 20 connects onto a first stage 14 of scuba regulator 12 at a proximal end via a sensor housing 22, while a distal end of tube 20 connects onto a buoyancy compensator hose 26 via a battery housing 24. In operation, visual broadcast device 10 provides a user interface and a dive planning system that presents a distributed light source with an array of unique illumination zones, or regions, that each correlate with a unique condition of gas in tank 16. In the present implementation, device 10 detects air pressure within tank 16.

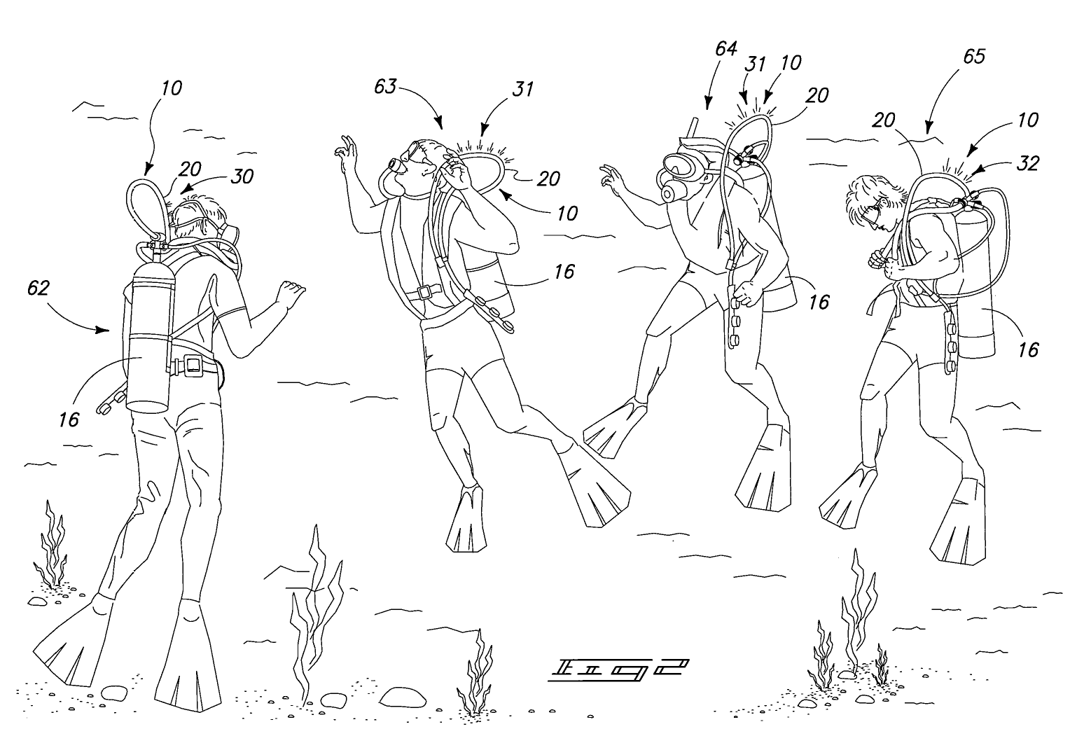

FIG. 2 illustrates a scuba diving instructor 62 underwater with a class of scuba diving students 63-65, each having the visual broadcast device 10 of the present invention. Optionally, instructor 62 could be a scuba diving guide. Further optionally, divers 62-65 could be a group of firefighters inside a burning building where visibility is limited and air pressure monitoring is critical. A similar concern is provided by divers in murky water.

Diver 62 is able to monitor air supply pressure in tank 16 for each of divers 63-65, as well as his own. Likewise, any other diver can monitor the air supply pressure within tank 16 of divers remaining within a visible range of a respective tube 20 on a visual broadcast device 10. Diver 62 has a green illumination zone 30 visually displayed by hose 20. Divers 63 and 64 each have an orange illumination zone 31 visually displayed by their respective hose 20. Diver 65 has a red illumination zone 32 visually displayed by hose 20. Furthermore, zones 30, 31 and 32, in addition to displaying unique colors, also display light in unique regions along hose 20. Accordingly, divers in low light conditions or even color-blind divers can still discern which condition is being displayed even if they cannot discern the particular color being displayed.

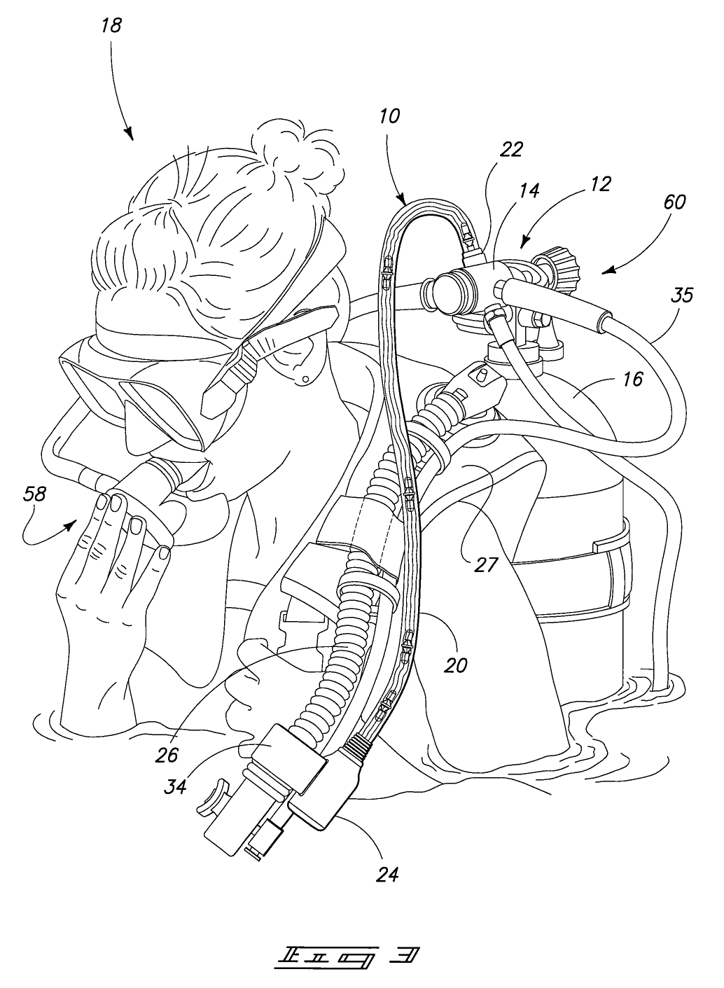

FIG. 3 depicts diver 18 on the water surface showing the connection of visual broadcast device 10 via sensor housing 22 to first stage 14 of regulator 12 and via battery housing 24 and strap 34 to buoyancy compensator hose 26 of buoyancy compensator 27. Buoyancy compensator hose 26 is also coupled to a reduced pressure, or second stage, pressure hose 35 from regulator 12 for supplying air to inflate buoyancy compensator 27. According to one construction, hose 20 is made from a clear and flexible plastic material, such as polyvinylchloride (PVC). Other suitable clear or translucent materials can also be used.

Sensor housing 22 connects in sealed relation with first stage 14 in direct communication with a high pressure port on first stage 14. However, hose 20 is not exposed to pressurized air as a sensor within housing 22 generates an output signal in proportion to air pressure detected at first stage 14 that indicates the pressure of air within tank 16. Hose 20 is constructed to house lights inside in a waterproof configuration, as will be discussed below in greater detail. Furthermore, sensor housing 22 is mounted onto first stage 14 of regulator 12 on a posterior side of diver 18, while battery housing 24 is mounted onto buoyancy compensator hose 26 on an anterior side 58 of diver 18. In this manner, the generation of light output from each unique illumination zone of hose 20 can be seen from a broad range of directions and distances.

FIG. 4 is a perspective view of the breathing gas supply visual broadcast apparatus 10 of FIGS. 1-3 prior to being mounted onto a scuba regulator and buoyancy compensator. More particularly, broadcast apparatus 10 provides an air supply warning apparatus that includes flexible plastic pressure indicator tube 20, pressure sensor housing 22 and battery housing 24. Sensor housing 22 is threaded into air pressure communication with a high pressure port on a first stage of a scuba regulator on a scuba tank. The scuba tank may also include a console with instrumentation, a mouthpiece, and air supply hoses for connecting to a pressure regulator. These components are conventional and well understood in the art, so they will not be further described and illustrated. However, these components are typically black which makes them hard to see and locate, especially in deep or murky water. Hence, visual broadcast apparatus 10 provides a highly visible means of determining the amount of air remaining in an air tank being worn by a scuba diver.

As shown in FIG. 4, the length and flexibility of tube 20 permits apparatus 10 to freely move in the water, and to be manipulated into a desired position by a diver or other observer, such as an instructor. Tube 20 is formed of flexible and transparent or translucent material, such a light-transmissive plastic or rubber, and has sealed therein light emitting diodes (LEDs) or other suitable light sources, such as fiber optic elements, to provide a visual indication of the pressure of the air in the air tank. One exemplary length for tube is 30 inches. Other lengths are also suitable.

According to one construction, visual broadcast apparatus 10 is a pressure indicator tube having a plurality of light sources that are activated in unique groupings to generate an array of unique illumination zones in tube 10, where each zone correlates with a unique condition, or pressure, of gas in the breathing gas supply system. As discussed below with reference to FIGS. 7-9, light sources are provided by individual LEDs. The LEDs are electrically interconnected by conductive wiring to circuitry in sensor housing 22 and circuitry in battery housing 24. The LEDs are illuminated in a manner to provide a bright, easily visible and chromatically distinguishable indication of air pressure in the tank to the diver and others nearby.

The light source, or LEDs, generate three unique illumination patterns having three unique colors: green, yellow, and red. More particularly, a green illumination pattern is provided within zone 30; a yellow illumination zone is provided within zones 29 and 31, and a red illumination pattern is provided within zones 28 and 32. Green illumination zone 30 is provided, in use, along an anterior position of a diver and indicates a “safety” condition indicating an ample supply of breathing gas, or pressurized air. Yellow illumination zones 29 and 31 are activated together and are present along an anterior position and a superior position, respectively, of a diver. Yellow illumination zones 29 and 31 indicate a “caution” condition indicating a moderate supply of breathing gas, or pressurized air. Red illumination zones 28 and 32 are activated together and are present along an anterior position and a posterior position of a diver. Red illumination zones 28 and 32 indicate a final “danger” zone indicating a low supply of breathing gas, or pressurized air.

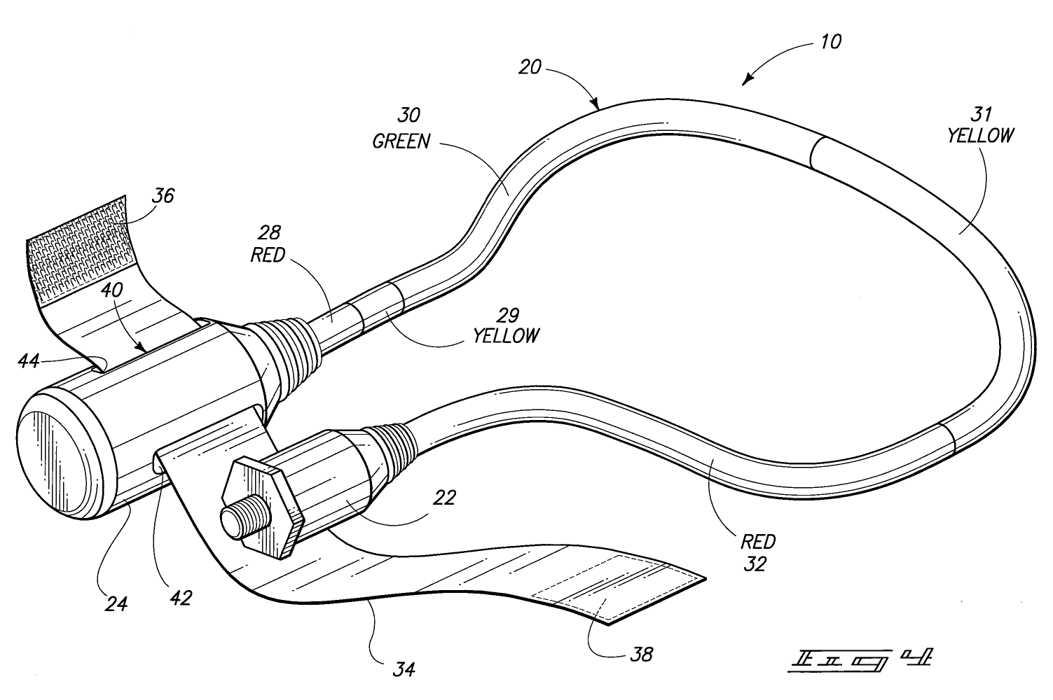

FIG. 5 illustrates in simplified block diagram form a construction for visual broadcast device 10 as coupled onto a regulator 12 of a pressurized air tank 16, such as a scuba tank. More particularly, device 10 includes a controller 138 having processing circuitry 139 that communicates with lights 150 provided within a flexible and transmissive tube 20. According to one construction, lights 150 comprise arrays of various LEDs 152, 154, each driven by a driver 155. Controller further includes memory 141. Switching circuitry 134, including a rotary switch, communicates with processing circuitry 139 in controller 138 to enable and disable groups of lights 150 within tube 20 in selected patterns that cover certain select illumination zones. Switching circuitry 134 also initiates power on and power off between battery 108 and lights 150. Processing circuitry 139 also communicates with a speaker 135. Controller 138 can direct speaker 135 to trigger an audible alarm based upon a condition of breathing gas that is detected by a pressure sensor 82 in communication with regulator 12. Pressure sensor 82 communicates with controller 138 to deliver a signal that is detected at regulator 12 correlating with a detected pressure in air tank 16.

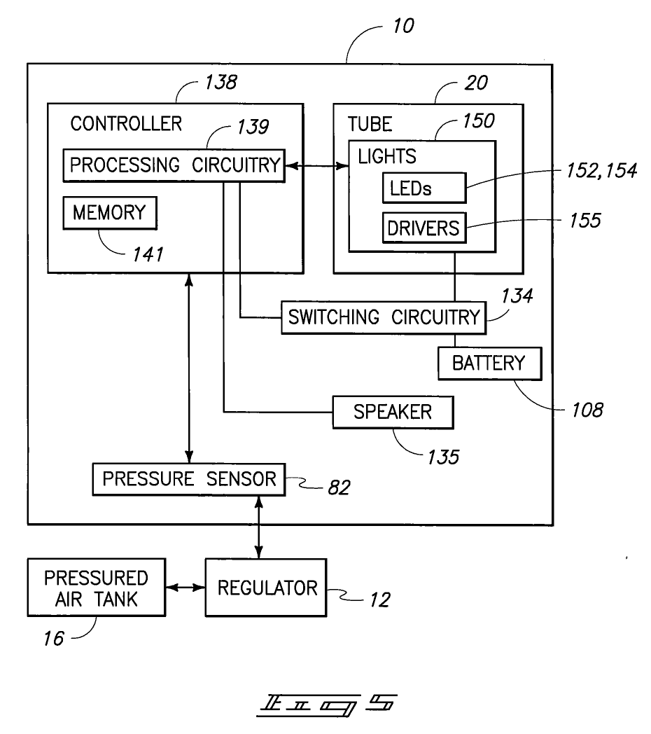

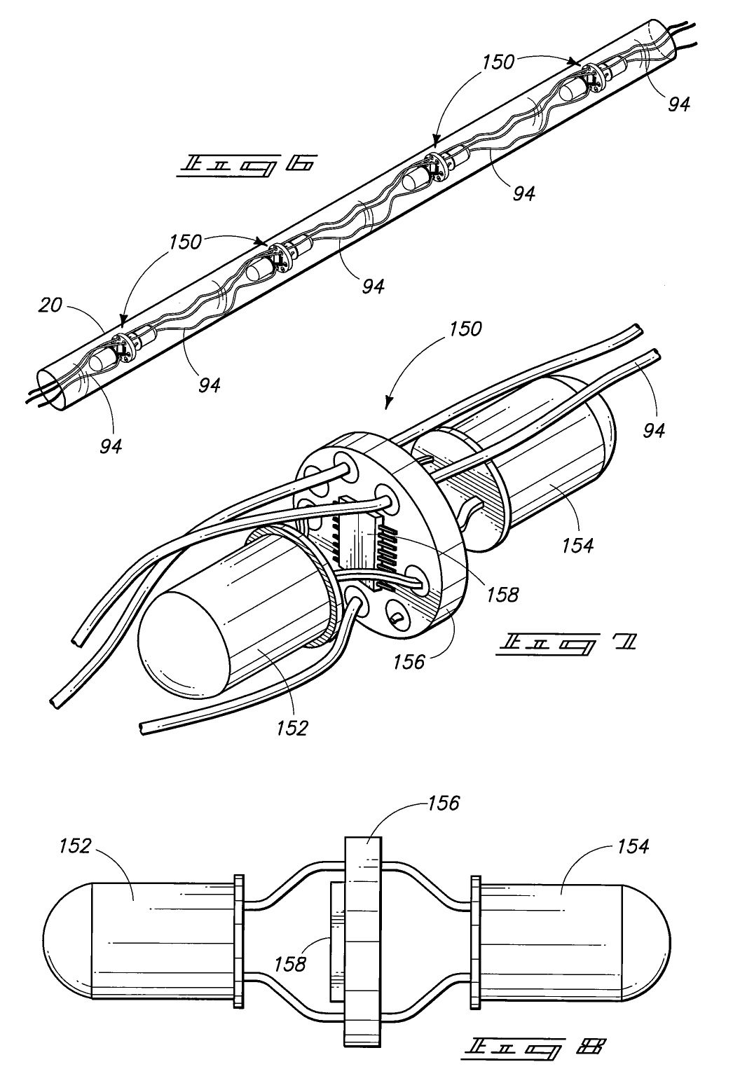

FIG. 6 illustrates one exemplary implementation for a flexible, transmissive tube 20. More particularly, lights 150 each comprise an array of individual LEDs 152 and 154 (see FIGS. 7 and 8) provided on a common printed circuit board 156 and having associated operating circuitry 158 provided therealong. Optionally, surface mount LEDs could be used. Conductive traces 94 are used to serially connect together individual lights 150 within tube 20. According to one construction, tube 20 terminates in sealing engagement at each end via sensor housing 22 and battery housing 24 (see FIG. 3) with a conical compression clamp. In one case, a conical compression collar seals the ends of tube 20 to housings 22 and 24. Additionally, a clear, flexible and resilient material is inserted within tube 20 prior to final assembly, such as a silicon material which is cured after insertion into tube 20. Configuration of individual LEDs 152 and 154 are shown in relation to PC board 156 and operating circuitry 158. According to one implementation, operating circuitry 158 comprises a local microcontroller.

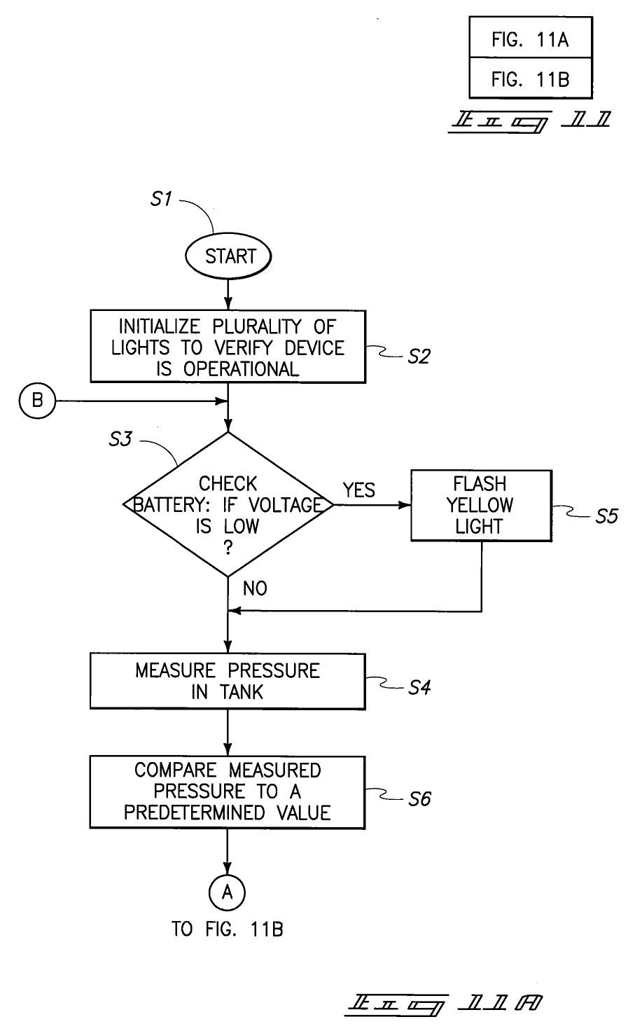

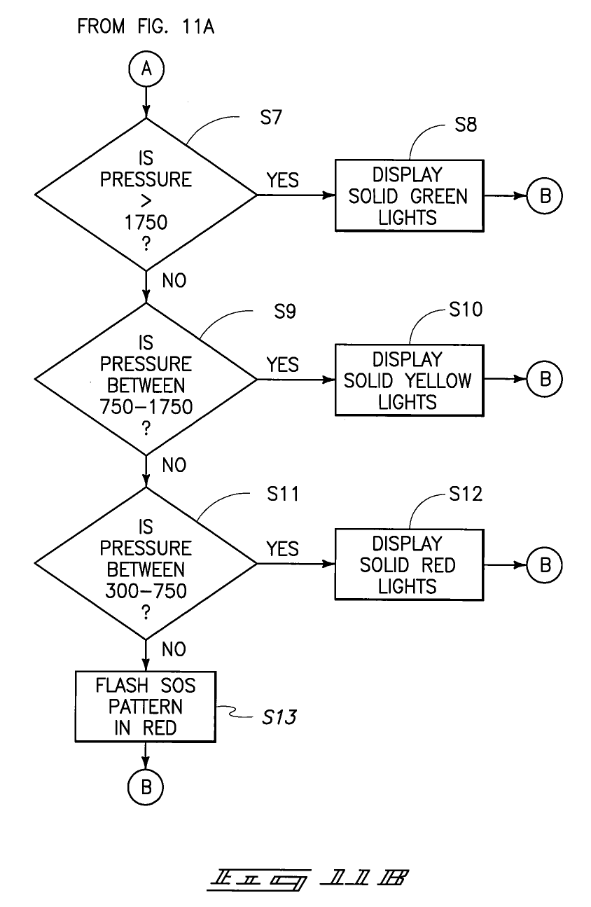

FIG. 11 is a process flow diagram illustrating a process for illuminating zones within the visual broadcast device 10 of the present invention. In step “S1”, the process is initiated. After step “S1”, the process proceeds to step “S2”.

In step “S2”, the process initializes a plurality of lights to verify the broadcast device is operational. After performing step “S2”, the process proceeds to step “S3”.

In step “S3”, the process checks the battery to determine if the battery voltage is low. If the battery voltage is low, the process proceeds to step “S5”. If the voltage is not low, the process proceeds to step “S4”.

In step “S4”, the process measures pressure detected in the tank. After performing step “S4”, the process proceeds to step “S6”.

In step “S5”, the process initiates flashing of the yellow lights.

In step “S6”, the process compares measured pressure to a predetermined value. After performing step “S6”, the process proceeds to step “S7”.

In step “S7”, the process determines whether the pressure is greater than 1750 psi. If the pressure is greater than 1750 psi, the process proceeds to step “S8”. If not, the process proceeds to step “S9.”

In step “S8”, the process initiates display of solid green lights.

In step “S9”, the process determines whether the pressure is between 750 psi and 1750 psi. If the pressure is between these values, the process proceeds to step “S10.” If not, the process proceeds to step “S11.”

In step “S10”, the process initiates display of solid yellow lights.

In step “S11”, the process determines whether the pressure is between 300 psi and 750 psi. If the pressure is between these values, the process proceeds to step “S12”. If not, the process proceeds to step “S13”.

In step “S12”, the process initiates display of solid red lights. After performing each of steps “S8”, step “S10”, and step “S12”, the process proceeds back to step “S3”.

An air supply device having an air supply warning system according to an embodiment of the invention is illustrated in FIG. 12 and shown generally at reference numeral 2100. Like the device 2010, the device 2100 includes a console 2111, a pressure gauge 2112, a mouth piece 2113, air supply hoses 2114 and 2115, and a pressure regulator 2117. A mechanical pressure gauge 2112 is illustrated, but an electronic pressure gauge or dive computer with a digital display may also be used. However, the device 2100 incorporates a visual and audible air supply warning system to provide an indication of pressure in an air tank. While the invention is being described with reference to air supply devices for scuba diving, it should be appreciated that the invention may be used in any suitable air supply system, for example, fire fighter air supplies.

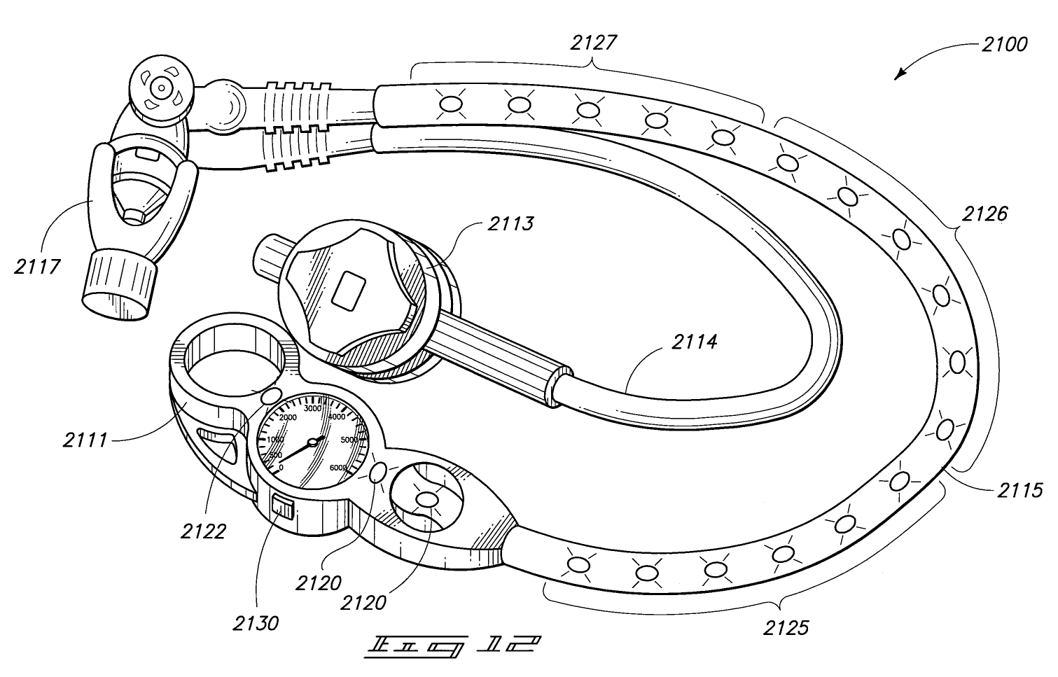

At least one of the console 2111 and air hose 2115 is made of a transparent or translucent material, such as plastic or rubber, instead of black and incorporate light emitting diodes (LEDs) or other suitable light sources to provide a visual indication of the pressure of the air tank. FIG. 13 shows a “two-hole” console 2111 while FIG. 14 shows a single gauge console 3111 (which may be modular to accept additional components such as a dive computer or compass). As shown, the console 3111 includes LEDs 3120, 3121, and 3122, a gauge 3112, and a button 3130. Any other suitable design for holding a pressure gauge may be used. The console 3111 includes a red LED 3120, a yellow LED 3121, and a green LED 3122. The air hose 2115 includes three sets of LEDs similar to LEDs 2125, 2126, and 2127 in FIG. 12. Similar to the version in FIG. 12, the first set of LEDs 3125 are green and light up a first portion of the air hose 3115. The second set of LEDs 3126 is yellow and light up a second portion of the air hose 3115. The third set of LEDs 3127 is red and light up a final portion of the air hose 2115 (see FIG. 12). As shown, LEDs 3120-3122 are positioned in the same order as LED sets 2125-2127 in FIG. 12 to provide a uniform warning system. However, LEDs 3120-3122 may be positioned in any suitable position on the console 2111.

The pressure gauge 2112 of FIG. 13 includes an electrical circuit (not shown) that is electrically connected to the LEDs 2120-2122 and 2125-2127 to energize the LEDs 2120-2122 and 2125-2127 according to the pressure detected by the gauge 2112. For example, when the air tank is full, the green LED 2122 lights up the console 2111 and all of the LEDs 2125-2127 light up the air hose 2115. When the gauge 2112 detects an intermediate pressure level (e.g. 1000 psi) in the tank, the yellow LED 2121 lights up the console 2111 and the green LED set 2125 turns off, leaving only the LED sets 2126 and 2127 to light up the air hose 2115. In addition, a beeping sound may be emitted by a speaker in the gauge 2112 or console 2111 to provide an audible signal that the air tank is getting low. The LEDs 2121 and 2126-2127 may also flash. The audible signal and flashing LEDs may be stopped be depressing button 2130. When the air pressure detected by the gauge 2112 reaches a low pressure level (e.g. 500 psi), the read LED 2122 will light up the console 2111, the LED set 2126 will turn off, leaving only the LED set 2127 to light up the hose 2115. Additionally, the gauge 2112 or console 2111 may emit an audible sound and the LED set 2127 will flash. At this point the device 2100 may be programmed so that the audible signal and flashing LED set 2127 cannot be turned off by depressing the button 2130.

It should be appreciated that the console 2111 may contain the electrical circuit for energizing the LEDs 2120-2122 and 2125-2127. In this instance, the gauge 2112 would make electrical contact with the electrical circuit when installed to allow the circuit to receive signals corresponding to the pressure in the tank from the gauge and energize the LEDs as described.

The air hose 2115 is preferably sectioned into three separate LED sets that operate independently. When scuba diving in deep water, the colors of the LEDs 2120-2122 and 2125-2127 may become indistinguishable and appear only as while light. Thus, simply changing the color of the console 2111 and hose 2115 would not provide a suitable visual indication of air pressure in the tank. By turning off sections of the LEDs 2125-2127, the hose 2115 acts like a “gas gauge” or bar graph. When all three LED sections 2125-2127 are operating, the divers know that they have adequate air in the tank. When only two sections 2126-2127 are operating, the individual knows that the air in the tank is getting low and that he should begin to ascend to the surface of the water. When only one LED section 2127 is operating, the diver knows that he is in danger of running out of air and needs to ascend to the surface of the water immediately. More importantly, this gas gauge effect also allows other divers to view the air supply of another diver from a distance, thereby allowing guides or other diving companions to instruct the diver to ascend to the surface of the water.

It should also be appreciated that the LEDs 2120-2122 of FIG. 12 may also operate in the same manner as the LED sets 2125-2127 of FIG. 11. Thus, when the tank is full all three LEDs 2120-2122 will be energized.

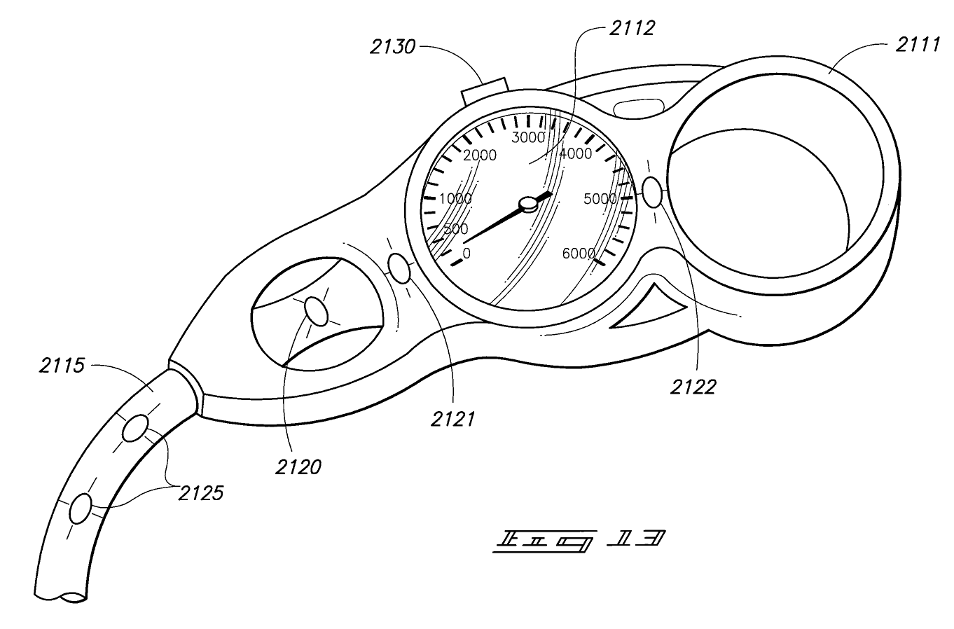

Referring to FIGS. 15 and 16, an air supply warning system according to another embodiment of the invention in the form of a hose cover 4210 and pressure gauge 4212 is illustrated. Like the air hose 4115, the hose cover 4210 includes three sets of LEDs 4225-4227. The hose cover 4210 and gauge 4212 are designed to be used with existing air supply devices, such as a traditional two-stage scuba regulator and tank, and will be discussed with reference to the air supply device 4010.

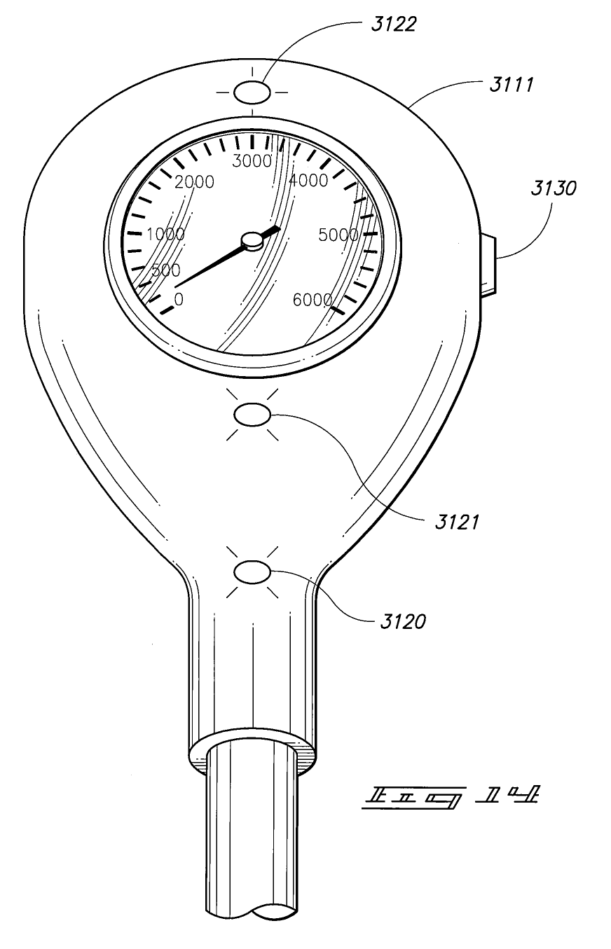

FIG. 17 illustrates an alternative construction broadcast device 2010 wherein a snorkel is provided having a double wall, with a clear outer wall 2020 terminating in a mouthpiece 2011. Device 2010 includes an array of lights, such as the previously discussed LEDs distributed between the walls of device 2010, and viewable through clear outer tube 2020. Additionally, a battery pack and a sonic receiver are configured to receive control signals that determine the specific lights that are illuminated in each specific illuminated zone of device 2010.

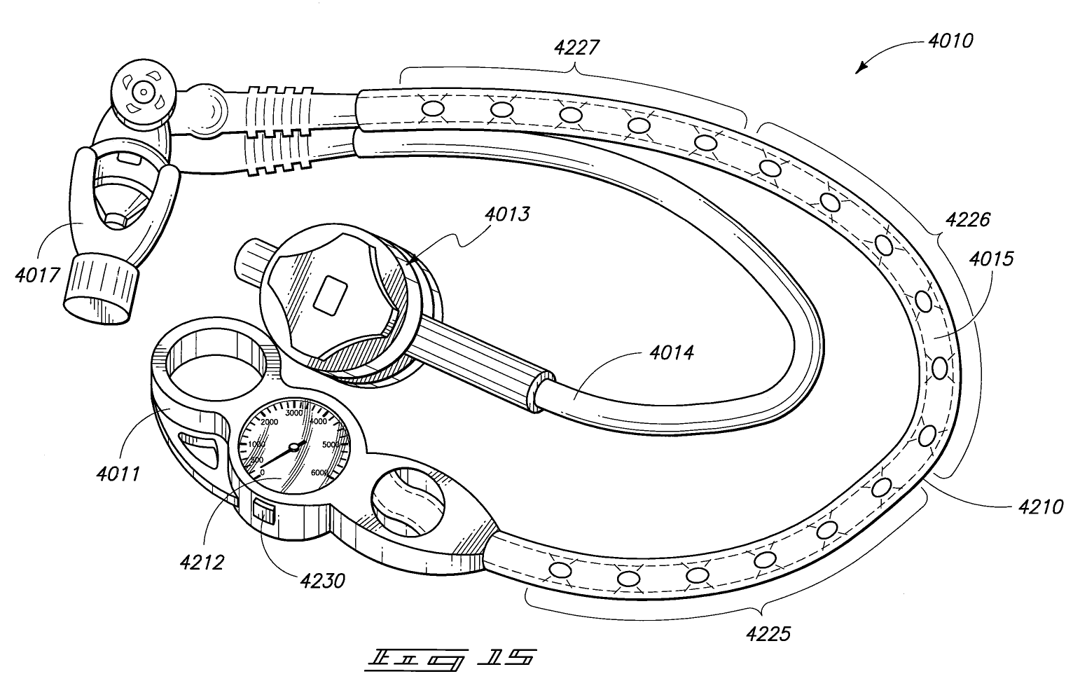

FIG. 18 illustrates another alternatively constructed visual broadcast device 3010 provided in the form of a clear and flexible double walled sleeve 3020 including an array of lights, such as LED lights distributed between the inner and outer walls. Tubular sleeve 3020 is sized to be received over a high pressure hose on a scuba tank pressure gauge which mates to a high pressure port provided on a distal end of pressure sensor 3022 within tube 3020. Pressure sensor 3022 is subsequently mated to a high pressure port on a first stage of a scuba regulator to detect pressure within an accompanying scuba tank.

FIG. 19 illustrates yet another alternative construction for a visual broadcast device 4010 including a flexible and light transmissive tube 4020 similar to tube 20 shown in previous constructions and including a plurality of lights, such as LED lights distributed therein. Tube 4020 is mounted onto a battery holder and receiver housing 4024 that includes an LED driver and is configured to receive control signals from a sonic transmitter 4026. Housing 4024 also includes batteries for supplying power to the lights within tube 4020. Sonic transmitter 4026 is configured to be mounted onto a first stage high pressure port of a scuba regulator and is operative to detect pressure conditions and send control signals to sonic receiver 4024 to direct the illumination of individual lights within tube 4020 in specified illumination zones.

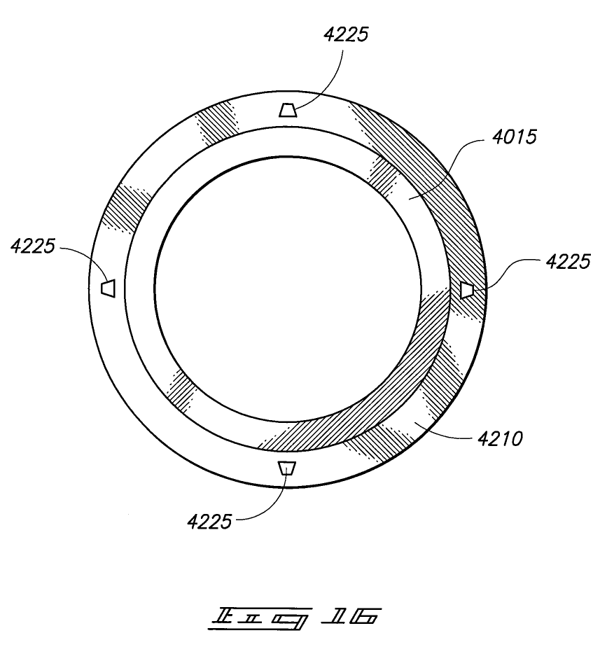

FIG. 20 illustrates yet even another version for visual broadcast device 5010. Device 5010 includes a flexible and light transmissive tube 5020 having a plurality of lights, such as LEDs contained therein operative to be illuminated in specific illumination zones in patterns as previously discussed in the other embodiments. Tube 5020 communicates with a sensor housing 5022 that couples with a first stage of a scuba regulator and a battery housing 5024. Battery housing 5024 is provided with positive buoyancy so as to serve as a float that vertically elevates tube 5020 when attached to a scuba tank regulator. Such a configuration enhances visibility of the lights within tube 5020 to accompany divers in a dive party.

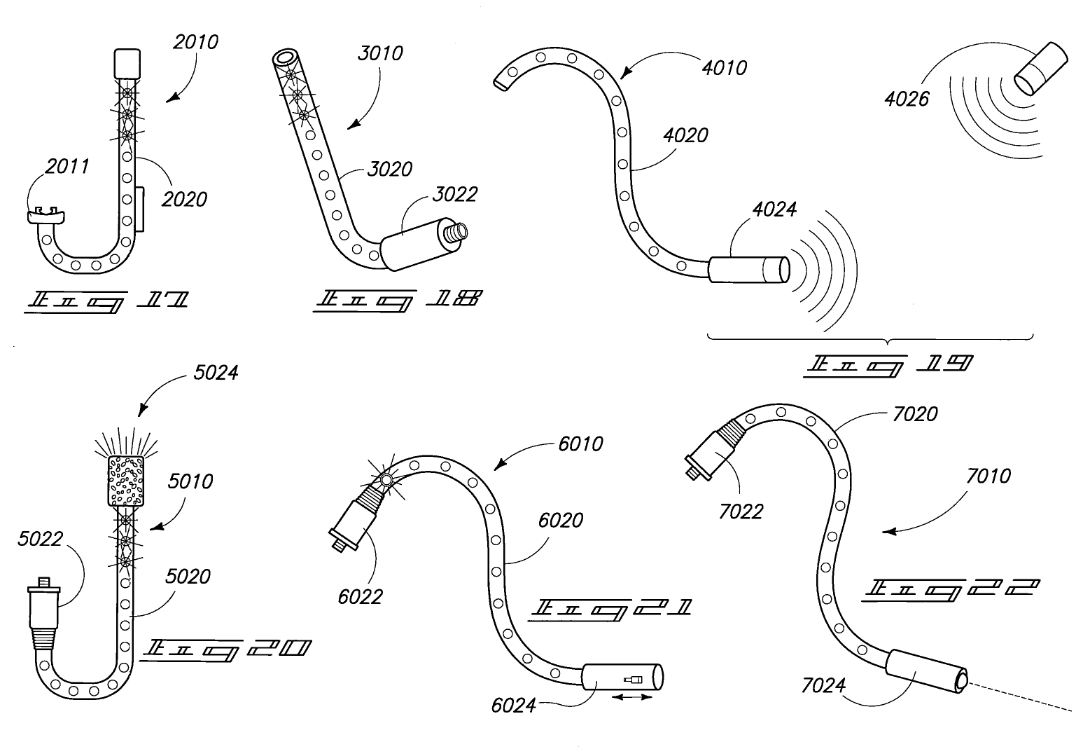

FIG. 21 is even another version of visual broadcast device 6010 including a flexible light transmissive tube 6020 provided between a sensor housing 6022 and a battery housing 6024. However, battery housing 6024 includes a tactile switch that enables a user to turn on a specific light source that is exceptionally bright adjacent to sensor 6022. Accordingly to one implementation, the exceptionally bright light comprises a super bright LED that is activated to flash in an “SOS” pattern responsive to the switch on battery housing 6024 being activated by user.

FIG. 22 illustrates yet even another version of visual broadcast device 7010. More particularly, device 7010 includes a flexible, light transmissive tube 7020 provided between a sensor housing 7022 and a battery housing 7024. However, battery housing 7024 includes a laser pointer that can be activated by a user to point at items underwater and to be used as a long distance beacon. Optionally, the laser pointer features of battery housing 7024 can be automatically activated through control circuitry responsive to a detected condition on the pressurized air supply. Further optionally, a manual switch can be provided for the user to activate the laser pointer at the user's discretion.

It is to be understood that the above description is intended to be illustrative, and not restrictive. For example, the above-described embodiments (and/or aspects thereof may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as plain-English equivalents of the respective terms “comprising” and “wherein.” Moreover, in the following claims, the terms “first” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The invention claimed is:

1. A user interface for a breathing gas supply system, comprising:
a distributed light source having a plurality of illumination zones, each illumination zone correlated with a condition of the gas in a breathing gas supply system.

2. The user interface of claim 1, further comprising a base provided on the light source and having a retainer for mounting to the breathing gas supply.

3. The user interface of claim 2, wherein the retainer comprises a first retainer, and further comprising a second retainer spaced from the first retainer, the first retainer configured to affix onto a posterior component of the breathing gas supply system and the second retainer configured to affix onto an anterior component of the breathing gas supply system.

4. The user interface of claim 1, wherein the illumination zones each comprise a mutually exclusive illumination zone identifiable from a third party viewed as to one of: a) a location; and b) a color to notify the third party of the condition of the breathing gas supply.

5. A breathing gas supply planning system, comprising:
a controller coupled to a power supply, the controller
an elongate light pipe including a plurality of optically discernible illumination zones, each zone is uniquely positioned and is illuminated based on a corresponding and condition of the air supply.

6. The breathing gas supply planning system of claim 5, wherein each illumination zone corresponds to a range of supply pressure for breathing gas in the breathing gas supply system.

7. The breathing gas supply planning system of claim 6, wherein the light pipe comprises a flexible, light-transmissive tube encasing a plurality of light emitting diodes coupled to a controller and a power supply, spaced apart within the tube, and the controller configured to operate selected light emitting diodes within an illumination zone that correlate to a condition of the breathing gas.

8. The breathing gas supply planning system of claim 5, further comprising a sensor communicating with the controller and positioned relative to a supply of breathing gas to detect the condition of the breathing gas.

9. An air supply status indicator, comprising:
an elongate light tube having a plurality of unique, optically discernible illumination regions each viewable about an entire cross-sectional periphery of the tube.

10. The air supply status indicator of claim 9, further comprising a plurality of light sources.

11. The air supply status indicator of claim 9, wherein the light tube is light transmitting.

12. The air supply status indicator of claim 9, further comprising a sensor mounted to an air supply source and configured to detect a condition of the air.

13. The air supply status indicator of claim 9, further comprising a plurality of diodes.

14. A breathing gas supply apparatus, comprising:
a sensor configured to detect a condition of a breathing gas supply and generate an output signal correlated with the detected condition;
processing circuitry configured to receive the output signal from the sensor;
memory communicating with the processing circuitry and operative to store the output signal;
a power supply to provide power to the sensor and processing circuitry;
a flexible light transmissive tube communicating at a proximal end with the pressure sensor and a distal end with the power supply; and
at least one light source communicating with the power supply and processing circuit, the light source provided in the tube and configured to illuminate a plurality of optically distinct illumination regions within the tube, each region illuminated to indicate the detected condition of the breathing gas supply.

15. The breathing gas supply apparatus of claim 14, wherein each of the plurality of optically distinct illumination regions is illuminated to display a unique color of light.

16. The breathing gas supply apparatus of claim 14, further comprising a first housing provided at the proximal end of the tube and configured to house the sensor.

17. The breathing gas supply apparatus of claim 16, further comprising a second housing provided at a distal end of the tube and configured to house the power supply.

18. The breathing gas supply apparatus of claim 14, further comprising a switch coupled to the processing circuitry to configure a change an operating state of the processing circuitry, the switch located on a second housing.

19. The breathing gas supply apparatus of claim 14, further comprising an audible output speaker, the speaker located in a first housing, the speaker further connected to a switch that is configured to trigger the processing circuit to generate an audible signal to be output from the speaker, the audible signal provides a user an alert status based on a condition of the breathing gas supply.

20. The breathing gas supply apparatus of claim 14, wherein the light source comprises at least one of a diode, a light emitting diode (LED), a halogen light source, an infrared light source, a neon light source, a tungsten halogen light source, a deuterium light source, a mercury-argon light source, a xenon light source, and a fiber optic light source.

21. The breathing gas supply apparatus of claim 14, wherein the light source comprises a plurality of light sources configured as a plurality of sets of lights, each set of lights provides a visual broadcast based on the detected condition of the gas supply.

22. A method for planning a scuba diving event where a scuba diver utilizes a gas supply apparatus having a tank with a pressure gauge connected to a sensor, and a processor coupled to the sensor and a plurality of lights, the sensor configured to detect at least a pressure of the gas supply and communicatively coupled to the plurality of lights, comprising:
checking at least one set of lights are illuminated to indicate the gas supply is full and at a predetermined level;
diving under a body of water;
verifying the first plurality of lights remain illuminated in the water and visible as the diver descends deeper in the body of water; and
monitoring for a change in the lights as the sensor determines changes in the gas pressure.

23. The method according to claim 22, further comprising ascending from the dive based on the lights indicating a low pressure condition of the gas supply in the tank.

24. The method according to claim 22, wherein the plurality of lights comprise at least three sets of lights, each set of lights indicating a different pressure condition of the gas supply in the tank.

25. The method according to claim 22, wherein the plurality of lights are grouped into at least three sets of different colored lights, each color configured to indicate a different condition of the gas supply.
